(19) United States
(12) Patent Application Publication
(10) Pub. No.: US 2002/0059223 A1
(43) Pub. Date: May 16, 2002

(54) Locator based assisted information browsing

(76) Inventors: Paul R. Nash, Bellevue, WA (US); G. Eric Engstrom, Kirkland, WA (US); Swain W. Porter, Kirkland, WA (US)

Correspondence Address: COLUMBIA IP LAW GROUP, PC, 10260 SW GREENBURG ROAD, SUITE 820, PORTLAND, OR, 97223, US

(21) Appl. No.: 10/010,973

(22) Filed: Dec. 5, 2001

Related U.S. Application Data
(63) Continuation-in-part of application No. 09/452,328, filed on Nov. 30, 1999.

(51) Int. Cl. G06F 7/00

(52) U.S. Cl. 707/5; 709/217

(57) ABSTRACT

An automated method including automatic conditional provisioning of replacement and/or additional information display for assisting a user of the client system in retrieving and browsing information is disclosed. Under the method, in response to the retrieval and display on a display of a client system a first information page, the assistance display is conditionally provided automatically. The automatic conditional provisioning is based at least in part on the locator of the first information page, employing a number of locator based conditions. In one embodiment, the locator based conditions are URL patterns specifying families of URLs. In one embodiment, the replacement/additional information pages may contain identifiers/locators for related information pages.

### RELATED APPLICATION

This application is a continuation-in-part application to U.S. patent application Ser. No. 09/452,328, filed on Nov. 30, 1999, entitled “Dynamic Content Based Assisted Information Browsing”. The specification of which is hereby fully incorporated by reference.

### BACKGROUND OF THE INVENTION

1. Field of the Invention

The present invention relates to the field of computerized information retrieval and browsing. More specifically, the present invention relates to methods and apparatuses associated with locator based assistance provided to facilitate information retrieval and browsing.

2. Background Information

With the recent advances in microprocessor, telecommunication and networking technology, increasing number of computer systems are being networked together through private and public networks, such as the Internet. Volumes of information stored on information servers (such as web servers of the World Wide Web) are now available to users of computer systems with a few clicks of a mouse button. For many users, the ease of access has actually created an information overload situation. An early solution has been to categorize as much of the information available as possible, such as the directory or index services offered by Internet portals like Yahoo and Lycos. Even then, a simple search restricted to one categorization could still result in hundreds of potential hits, requiring a large amount of user time to sort out the useless from the useful. As a result, users are frustrated, and information technology is prevented from realizing its full potential in reaching the ubiquitous state.

Various automated techniques in assisting a user in retrieving and browsing information have been proposed and/or experimented. In U.S. Pat. No. 5,727,129, entitled “Network system for profiling and actively facilitating user activities”, issued to Barrett et al, a system and method for assisting a user in accessing information stored at remote network sites was disclosed. Under Barrett, an archive is maintained of remote sites accessed and instances in which the same remote sites are accessed in sequence. Statistics regarding information such as the number of times a site has been accessed, and the times a given set of sites have been accessed in sequence are maintained. Based on this information, information items are identified which the user is predicted to be likely to want to access. In U.S. Pat. No. 5,960,429, entitled “Multiple reference hotlist for identifying frequently retrieved web pages”, issued to Peercy et al, a method and apparatus for locating web pages was disclosed. Under Peercy, a count of retrievals of a web page is accumulated and the accumulated count and an address for the web page are stored in a record of a history log database. A multiple reference hotlist is formatted for the user from the records in the history log.

Additionally, in co-pending application Ser. No. 09/452,328, entitled “Dynamic Content Based Assisted Information Browsing”, filed on Nov. 30, 1999, presently assigned to the same assignee, a method for providing information browsing assistance based on the contents of the information being browsed is disclosed.

Each of these techniques has its pros and cons. Additional techniques that can improve the ease of information retrieval and browsing, even in limited circumstances, with lesser demands on processing power, are nevertheless still desired.

### SUMMARY OF THE INVENTION

An automated method including automatic conditional provisioning of replacement and/or additional information display for assisting a user of the client system in retrieving and browsing information is disclosed. Under the method, in response to the retrieval and display on a display of a client system a first information page, the assistance display is conditionally provided automatically. The automatic conditional provisioning is based at least in part on the locator of the first information page, employing a number of locator based conditions. In one embodiment, the locator based conditions are URL patterns specifying families of URLs. In one embodiment, the replacement/additional information pages may contain identifiers/locators for related information pages.

### BRIEF DESCRIPTION OF DRAWINGS

The present invention will be described by way of exemplary embodiments, but not limitations, illustrated in the accompanying drawings in which like references denote similar elements, and in which:

FIG. 1 illustrates an overview of the present invention;

FIG. 2 illustrates a browser and the augmented locator (URL) based assistance function and data structure of FIG. 1 in further detail, in accordance with one embodiment;

FIGS. 3a-3c illustrate a number of example locators (URLs), locator based conditions (URL patterns) that encompass the example locators (URLs), and an XML like specification scheme for specifying assistance to be provided (URL Triggers) for the locator based conditions (URL patterns), in accordance with one embodiment;

FIG. 4 illustrates a locator based condition (URL pattern) data structure for storing locator based conditions (URL patterns), in accordance with one embodiment;

FIG. 5 illustrates the relevant aspect of the operational flow of the analyzer function of FIG. 2, in accordance with one embodiment;

FIGS. 6a-6b illustrate a number of alternative dispositions of the analyzer function and locator based condition data structure for practicing the present invention, in accordance with two embodiments; and

FIG. 7 illustrates an example digital system suitable for practicing the present invention.

### DETAILED DESCRIPTION OF THE INVENTION

As summarized, the present invention includes methods and apparatuses for providing information browsing assistance, based on the locators of information pages requested. In the following description, various aspects of the present invention will be described. However, the present invention may be practiced with only some or all aspects of the present invention. For purposes of explanation, specific numbers, materials and configurations are set forth in order to provide a thorough understanding of the present invention. However, the present invention may be practiced without the specific details. In other instances, well known features are omitted or simplified in order not to obscure the present invention.

Parts of the description will be presented using terms such as locators, identifiers, functions, data structures and so forth, commonly employed by those skilled in the art to convey the substance of their work to others skilled in the art. Parts of the description will be presented in terms of operations performed by a computer system, using terms such as parsing, accessing, retrieving, and so forth. As well understood by those skilled in the art, these quantities take the form of electrical, magnetic, or optical signals capable of being stored, transferred, combined, and otherwise manipulated through mechanical, electrical and optical components of a digital system. The term digital system includes general purpose as well as special purpose data processing machines, systems, and the like, that are standalone, adjunct or embedded.

Various operations will be described as multiple discrete steps performed in turn in a manner that is most helpful in understanding the present invention, however, the order of description should not be construed as to imply that these operations are necessarily order dependent, in particular, the order the operations are presented. Furthermore, the phrase “in one embodiment” will be used repeatedly, however the phrase does not necessarily refer to the same embodiment, although it may.

### Overview

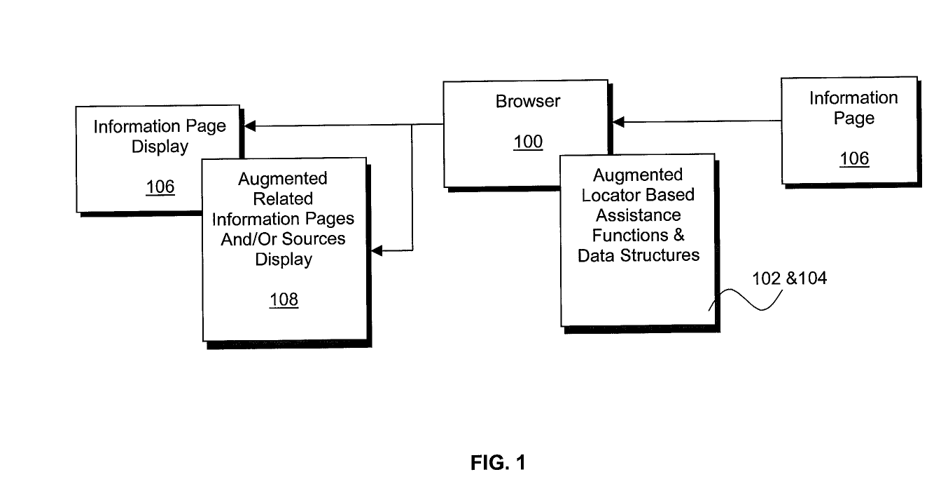

Referring now to FIG. 1, wherein an overview of the present invention, in accordance with one embodiment, is shown. As illustrated, for the embodiment, in accordance with the present invention, browser 100 is augmented with at least an information browsing assistance function 102 and a complementary data structure 104 to conditionally provide locator based information browsing assistance to a user retrieving and browsing information pages 106. More specifically, assistance function 102 and data structure 104 enable browser 100 to facilitate augmented conditional provisioning of replacement and/or additional complementary information pages 108, when corresponding locator based conditions are met. That is, the assistance information pages may be provided as replacement information pages (replacing the requested information pages) or additional information pages (complementary to the requested information pages). Further, in various embodiments, one or more of the replacement/additional complementary information pages 108 may include suggestions (having associated information source identifiers) of additional information pages.

Information pages 106-108 represent a broad range of informational units known in the art, including but not limited to information “documents” formed using mark-up languages, such as HTML and XML.

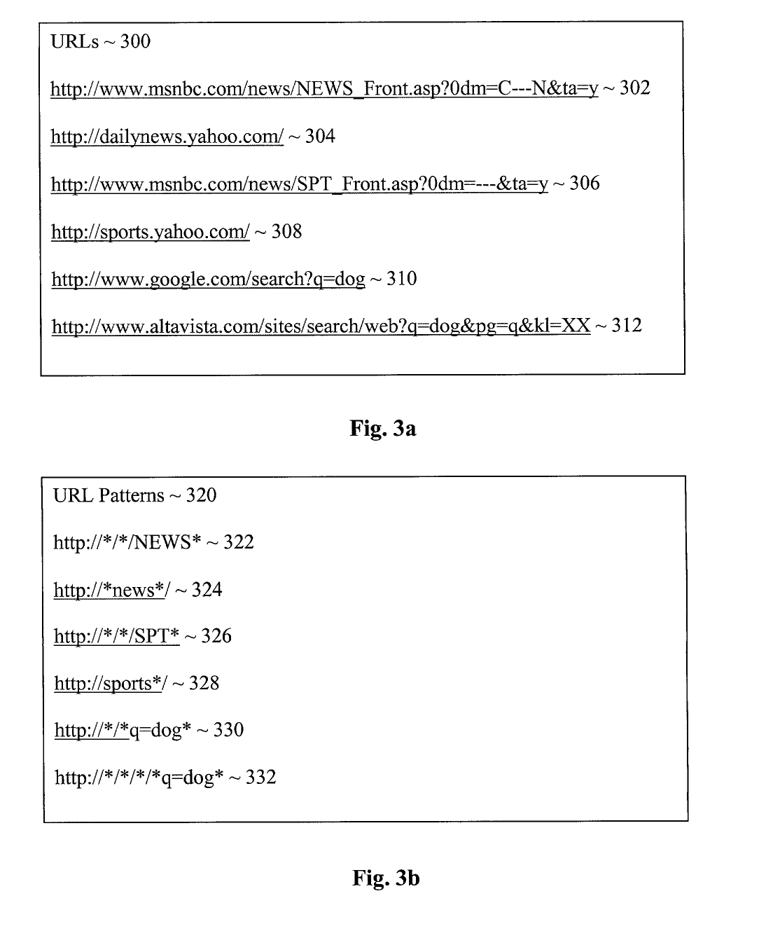

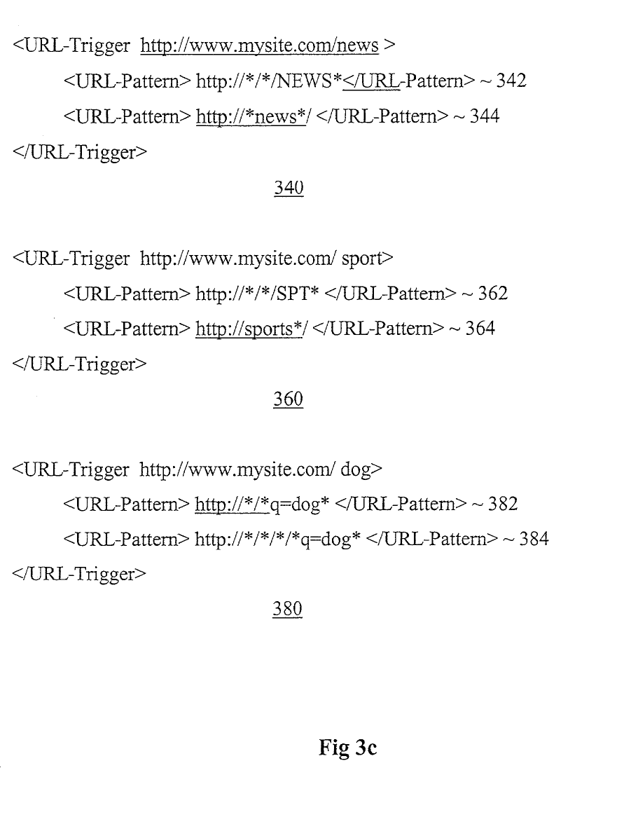

In one embodiment, the locators of the information pages are Uniform Resource Locators (URL) as specified by RFC2396 of the Internet Engineering Task Force, and the locator based conditions are URL based conditions. That is, information browsing assistance is provided if a pre-specified URL condition (having associated information browsing assistance to be provided) is met. As will be described in more detail below, in various embodiments, each of the URL conditions is expressed as an URL pattern (implicitly) specifying a family of URLs, and the associated information browsing assistance to be provided (when one of the implicitly specified URLs is requested), to be described more fully below referencing FIG. 3a-3c.

### Browser Architecture

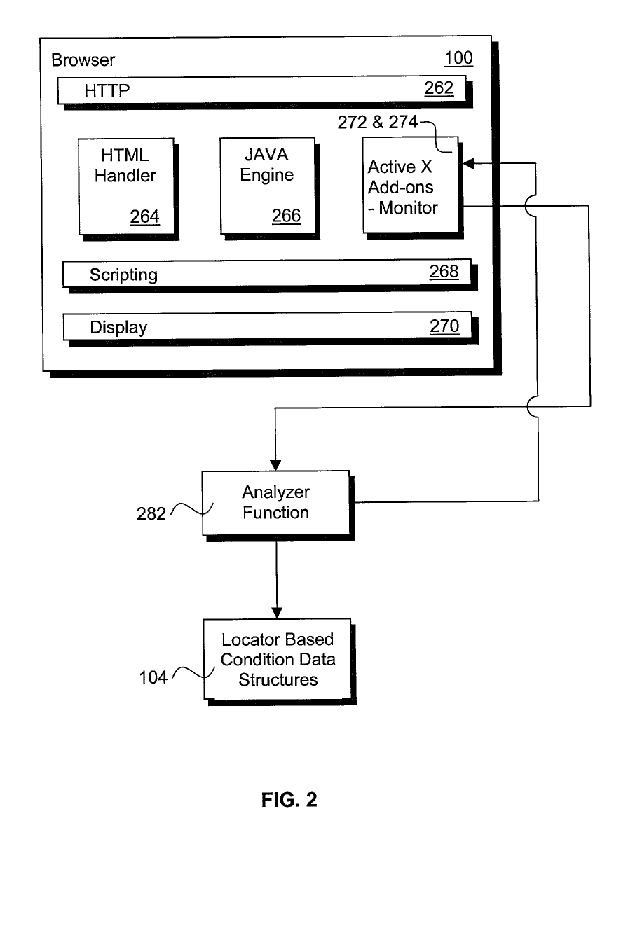

FIG. 2 illustrates augmented browser 100 in further detail, including its relation with information browsing assistance function 102 and complementary data structure 104, in accordance with one embodiment. As illustrated, browser 100 includes conventional elements found in many browsers known in the art, HTTP interface 262, HTML web page handler 264, JAVA™ and JavaScript execution engine 266, other script interpreter 268 (e.g. CGI), display interface 270, and a number of “plug-ins” (or add-ons), shown as additional ActiveX components 272-274. Included among these ActiveX components 272-274 is monitor function 272 of assistance function 102 responsible for interfacing with analyzer function 282 of assistance function 102. In other words, for the embodiment, assistance function 102 is distributively implemented with monitor function 272 being added to or integrated with browser 100.

Monitor function 272 registers itself with browser 100 to be notified of various browsing events of interest. In one embodiment, these browsing events of interest include in particular when browser 100 requests for information pages (e.g. in response to directions from a user). Upon receipt of these notifications, monitor function 272 relays the occurrence of these events to augmented assistance function 102.

In alternate embodiments, browser 100 may be equipped with the capabilities to interface with analyzer function 282 directly. In other embodiments, analyzer function 282 may also be integrated with browser 100 instead.

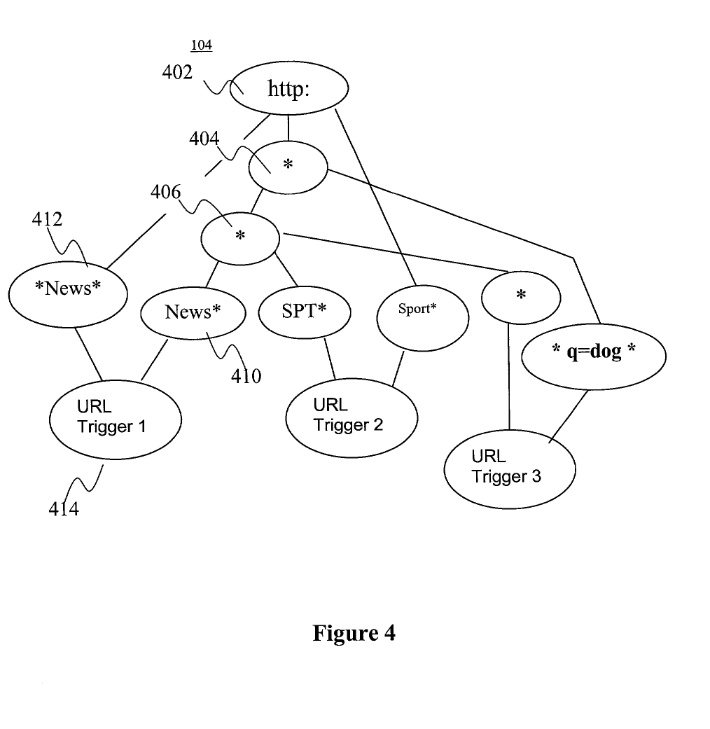

Data structure 104 stores the locator based conditions. As alluded to earlier, for the earlier described URL based embodiments, data structure 104 stores the URL patterns. In one embodiment, data structure 104 is a tree-like data structure, with different portions of a URL pattern store in corresponding nodes of the tree-like data structure, and the leaf node of these nodes storing the associated information browsing assistance to be provided, to be described more fully later referencing FIG. 4.

In one embodiment, an editor (not shown) is provided to facilitate entry of the URL patterns into data structure 104. In another embodiment, the URL pattern may be specified using pre-determined language elements (e.g. XML), and a reader (not shown) capable of comprehending the pre-determined language elements is provided to read the specified URL patterns (expressed using the pre-determined language elements), and store the specified URL patterns in data structure 104.

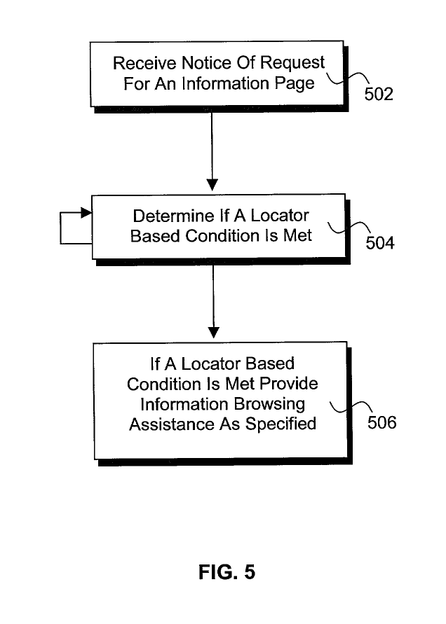

Augmented assistance function 102, more specifically, analyzer function 282, (as described in more detail below referencing FIG. 5), is equipped to determine whether a locator of a requested information page satisfies one of the pre-specified locator based conditions stored in augmented data structure 104. For the earlier described URL based embodiment, analyzer function 282 is equipped to determine whether the URL of a requested information page matches one of the pre-specified URL patterns stored in augmented data structure 104.

### Locator, Locator Based Conditions and Associated Browsing Assistance

FIG. 3a illustrates a number of example locators of information pages 300, more specifically, example URLs of information pages, in accordance with one embodiment. Example URLs 302 and 304 identify a “news” page each, available from the portals “msnbc” and “yahoo” respectively. Similarly, example URLs 306 and 308 identify a “sports” page each, available from the portals “msnbc” and “yahoo” respectively. Example URLs 310 and 312 identify a result page each, to be returned in response to a search having the keyword “dog”, available from the search engines “google” and “altavista” respectively.

Of course, as those skilled in the art will appreciate that example URLs 306 and 308 could be considered as identifying a “news” page each. In other words, the classification or differentiation of “sports” as a special category of “news” is arbitrary and application dependent. Further, from the description to follow, those skilled in the art will appreciate that the present invention may be practiced with a wide range of other similar locators or URLs.

FIG. 3b illustrates a number of example locator conditions 320, more specifically, example URL patterns that encompass the above example locators or URLs, in accordance with one embodiment. As illustrated, locator conditions or URL patterns 322 and 324 having the keyword “news” placed at the illustrated positions encompass the earlier described example locator or URL 302 and 304 respectively, and other news oriented information pages identified by locators/URLs of like kinds. An asterisk in locator condition or URL pattern 322/324 stands for a “wildcard” that may be satisfied by any value in the corresponding position of a locator/URL. In other embodiments other characters may be used in locator conditions to represent wildcard characters or specific matching behaviors. Pattern matching algorithms familiar to those skilled in the art such as regular expressions may also be employed. Similarly, locator conditions or URL patterns 326 and 328 having the keyword “SPTS” or “sports” placed at the illustrated positions encompass the earlier described example locator or URL 306 and 308 respectively, and other sports oriented information pages identified by locators/URLs of like kinds. Locator conditions or URL patterns 330 and 332 having the keyword “q=dog” placed at the illustrated positions encompass the earlier described example locator or URL 310 and 312 respectively, and other result information pages identified by locators/URLs of like kinds. Accordingly, each of locator conditions or URL patterns 320 implicitly identifies a family locators or URLs.

Assuming in each of these situations, i.e. for each locator or URL that satisfies these locator based conditions or URL patterns 322-332, the associated assistance is a corresponding assistance information page from a “help” web site “mysite”, the associated assistance may be specified using an XML like specification language, in accordance with one embodiment, as illustrated. For example, the “news” oriented assistance information page to be displayed from “mysite.com” when URL patterns 322-324 are met or matched, may be specified through URL trigger 340 enumerating the “news” information page to be displayed from “mysite.com”. URL trigger 340 comprises URL patterns 342-344, denoting the conditions under which the specified assistance is to be provided. For the embodiment, the URL patterns and the assistance to be triggered are specified using the XML like statements illustrated. Similarly, the “sports” oriented assistance information page to be displayed from “mysite.com” when URL patterns 326-328 are met or matched, may be specified through URL trigger 360 enumerating the “news” information page to be displayed from “mysite.com”. URL trigger 340 comprises URL patterns 342-344, denoting the conditions under which the assistance is to be provided. The “dog” oriented assistance information page to be displayed from “mysite.com” when URL patterns 330-332 are met or matched, may be specified through URL trigger 380 enumerating the “dogs” information page to be displayed from “mysite.com”. URL trigger 380 comprises URL patterns 382-384, denoting the conditions under which the assistance is to be provided. The described relationships in these examples are merely illustrative, and those skilled in the art will recognize that the scope of the present invention includes logical relationships between location conditions and URL triggers that are based on more than simple subject matches. In some embodiments, analyzer logic 282 may use arbitrarily complex decision factors to map an URL pattern to an appropriate assistance information page.

Even though only a handful of example locators, locator based conditions and associated assistance are illustrated, as alluded to earlier, those skilled in the art will appreciate the illustrated manner of specifying locator based conditions and the assistance to be provided may be practiced for a wide range of locators.

### Locator Based Condition (URL Pattern) Data Structure

FIG. 4 illustrates a locator based condition (URL pattern) data structure suitable for use to store locator based conditions (URL patterns) to practice the present invention, in accordance with one embodiment. As illustrated, for the embodiment, locator based condition or URL pattern data structure 104 is a tree like data structure comprising a number of nodes, e.g. nodes 402-414. Nodes 414 are said to be leaf nodes of predecessor nodes, such as nodes 402-410. The various portions of a locator based condition or a URL are stored in corresponding nodes. For example, the various portions of URL pattern 302 are stored in corresponding nodes 402-410, whereas the various portions of URL 304 are stored in nodes 402 and 410. Child node or URL Trigger 414 specifies the assistance or URL action to be triggered when the locator of a requested information satisfies the URL condition or matched the URL pattern.

As will be described in more detail below, in one embodiment, assistance function 102, more specifically, analyzer function 282 determines whether the locator or URL of the requested information page satisfies a locator based condition or matches a URL pattern by traversing the tree like data structure 104.

### Operational Flow of Assistance Function

FIG. 5 illustrates the relevant aspects of the operational flow of assistance function 102 (more specifically, analyzer function 282), in accordance with one embodiment. As illustrated, upon receipt of a notification of an information page request event from monitor function 272, block 502, analyzer function 282 determines if one of the locator based conditions is met, block 504. For the earlier described embodiment, where the locator based conditions are URL patterns, and the URL patterns are stored in a tree like data structure 104, analyzer function 282 traverses the tree like data structure 104 to determine if one of the URL patterns is met.

If locator based condition (URL pattern) is not met, for the embodiment, no information browsing assistance is provided. However, if one of the locator based condition (URL pattern) is met, analyzer function 282 causes the corresponding information browsing assistance to be provided, block 506. As described earlier, for the URL pattern embodiment, in particular, the embodiment where the URL patterns are stored in a tree like data structure, the assistance is specified in the leaf node of the nodes storing the matching URL pattern.

Further, these assistance may take the form of one or more replacement information pages and/or one or more additional complementary information pages. Whether replacement or additional information pages are provided, one or more of the assistance information page may comprise information source identifiers identifying information pages of potential interest (in view of the information page being requested).

### Disposition of Analyzer Function and Condition Data Structure

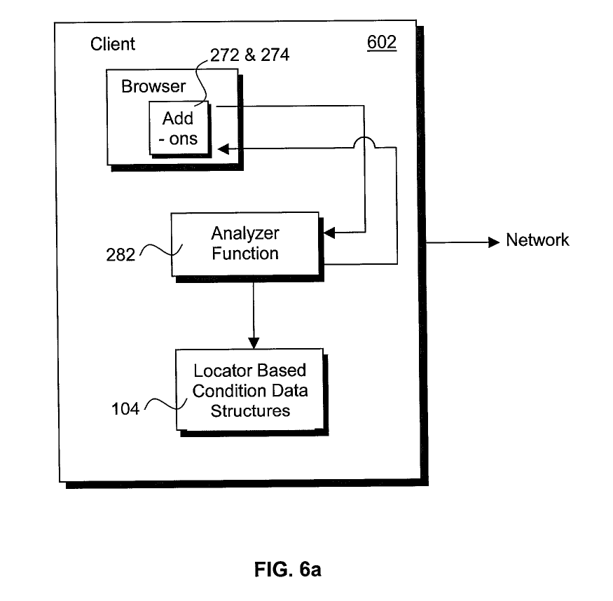

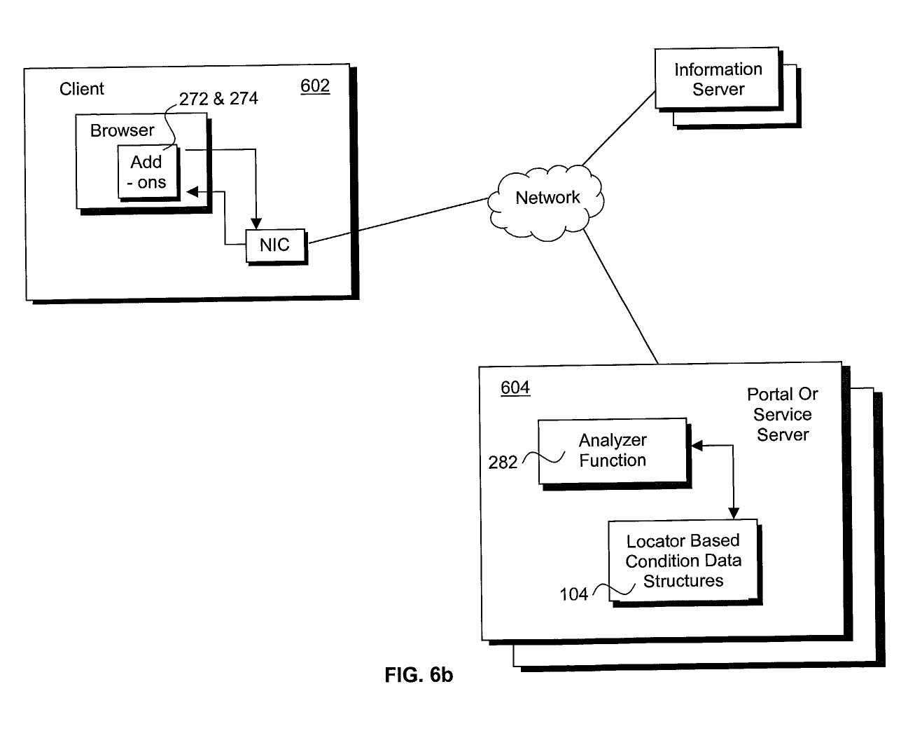

FIGS. 6a-6b illustrate two alternative dispositions of assistance function 102 and condition data structures 104, both suitable for practicing the present invention, in accordance with two embodiments. The embodiment of FIG. 6a represents an embodiment, where all the relevant earlier described elements, i.e. monitor function 272, analyzer function 282, and data structure 104 are all provided to a client system 602 coupled to a network (e.g. the Internet). These relevant elements may be loaded onto client system 602 via a distribution medium (not shown) or downloaded from a distribution server (not shown).

The embodiment of FIG. 6b represents an alternate embodiment, where only monitor 272 is provided to a client system 602 coupled to a network (e.g. the Internet). Otherwise, analyzer function 282 and data structure 104 are disposed on portal or service server 604 instead. During operation, upon being notified of a request for an information page, monitor function 272 notifies analyzer function 102 via the coupling network. The notification may be accomplished using any one of a number communication protocols known in the art. Analyzer function 282, using data structure 104, would perform the analysis, and if appropriate, triggers the information browsing assistance for client system 602 remotely from server 604. Similarly, monitor function 272 may be loaded onto client system 602 via a distribution medium (not shown) or downloaded from a distribution server (not shown). In selected embodiments, server 604 may also assume the role of the distribution server.

### Example Computer System

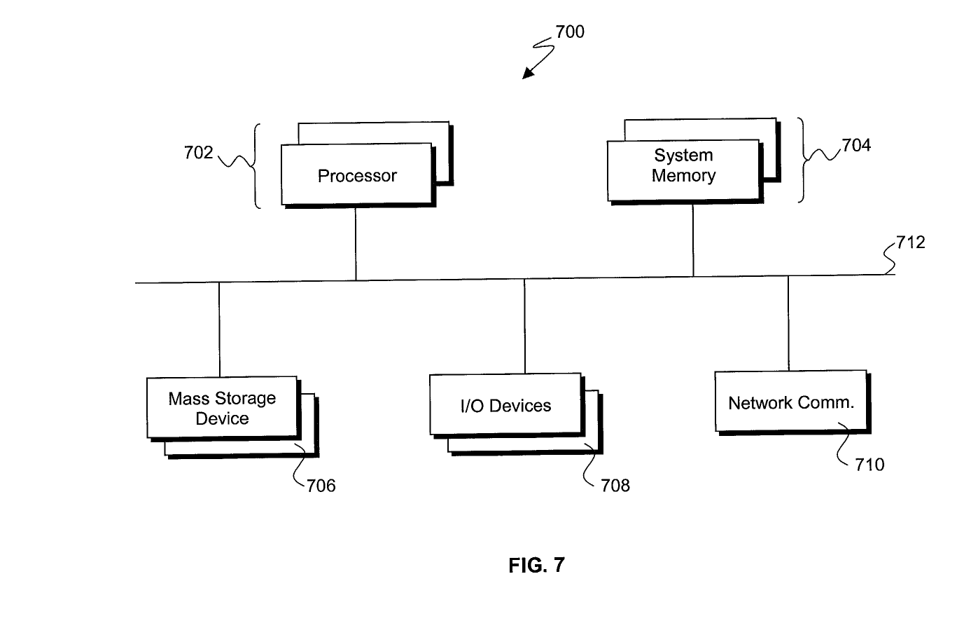

FIG. 7 illustrates one embodiment of an exemplary digital system suitable for use to practice the present invention, either as a client system or a server system. As a client system, digital system 700 may be a desktop computer system, a laptop computer system, a palm sized computing device, a wireless mobile phone, a set-top box, an Internet appliance and the like. As a server, digital system 700 may a single or a cluster of computer systems. As shown, exemplary digital system 700 includes one or more processors 702 and system memory 704. Additionally, system 700 includes mass storage devices 706 (such as diskette, hard drive, CDROM and so forth), input/output devices 708 (such as keyboard, cursor control and so forth) and communication interfaces 710 (such as network interface cards, modems and so forth). The elements are coupled to each other via system bus 712, which represents one or more buses. In the case of multiple buses, the buses are bridged by one or more bus bridges (not shown). Each of these elements performs its conventional functions known in the art. In particular, system memory 704 and mass storage 706 are employed to store a working copy and a permanent copy of the programming instructions implementing the teachings of the present invention. The permanent copy of the programming instructions may be loaded into mass storage 706 in the factory, or in the field, as described earlier, through a distribution medium (not shown) or through communication interface 710 (from a distribution server (not shown). The constitution of these elements 702-712 are known, and accordingly will not be further described.

### Conclusion and Epilog

Thus, a novel method and apparatus for assisting a user in information retrieval and browsing, based on the locator of a requested information page has been described. While the present invention has been described in terms of the above illustrated embodiments, those skilled in the art will recognize that the invention is not limited to the embodiments described. The present invention can be practiced with modification and alteration within the spirit and scope of the appended claims. The description is thus to be regarded as illustrative instead of restrictive on the present invention.

What is claimed is:

1. In a client system, an automated method for assisting a user of the client system in retrieving and browsing information, the method comprising:
determining based at least in part on a locator of a first information page requested to be retrieved and displayed, whether to provide information browsing assistance, said locator identifying the first information page and a location from which the first information page is to be retrieved; and
conditionally providing said information browsing assistance based at least in part on said determination.

2. The method of claim 1, wherein said locator is a uniform resource locator (URL).

3. The method of claim 1, wherein said determining comprises analyzing whether a locator based condition for providing information browsing assistance is met.

4. The method of claim 1, wherein
said locator is a uniform resource locator (URL);
said determining comprises analyzing whether said URL satisfies a URL based condition for providing information browsing assistance is met.

5. The method of claim 4, wherein
each URL based condition comprises a URL pattern specifying a family of URLs; and
said analysis comprises matching said URL against a plurality of URL patterns.

6. The method of claim 5, wherein
each URL pattern comprises a plurality of portions correspondingly stored in a plurality of nodes of a tree data structure, with the plurality of nodes having a child leaf node specifying information browsing assistance to be provided; and
said matching comprises traversing said tree data structure.

7. The method of claim 6, wherein the method further comprises downloading said tree data structure from a server system onto said client system.

8. The method of claim 5, wherein the method further comprises downloading said URL patterns and their corresponding information browsing assistance specifications from a server system onto said client system.

9. The method of claim 4, wherein the method further comprises downloading said URL based conditions and their corresponding information browsing assistance specifications from a server system onto said client system.

10. The method of claim 1, wherein said information browsing assistance comprises displaying a second information page.

11. The method of claim 10, wherein said second information page effectively replaces said first information page.

12. The method of claim 10, wherein said second information page is additionally displayed complementing said first information page.

13. The method of claim 10, wherein said second information page comprises a plurality of locators identifying a plurality of information pages and corresponding locations from which the identified information pages of said second information page are to be retrieved.

14. The method of claim 1, wherein said information browsing assistance comprises modifying an environment attribute of the browsing environment within which said determining and conditional provision of information browsing assistance are performed.

15. The method of claim 14, wherein said environment attribute is an environment attribute selected from a group of environment attributes comprising a display resolution attribute, a color resolution attribute, a font selection attribute, a media player preference attribute, an add-on selection attribute, and a plug-in selection attribute.

16. The method of claim 1, wherein the method further comprises receiving a request to retrieve and display said first information page, said request including said locator.

17. The method of claim 16, wherein the method further comprises
in response to said receive of a request, notifying a monitor function of a browser helper of said receipt; and
said monitor function, in response to receipt of said notification, notifying an analyzer function of said browser helper, which performs said determining and conditional provision of information browsing assistance.

18. The method of claim 17, wherein the method further comprises executing said monitor function as an extension of a browser, and executing said analyzer function external to said browser.

19. An apparatus comprising:
storage medium having stored therein executable instructions designed to enable the apparatus to
determine based at least in part on a locator of a first information page requested to be retrieved and displayed, whether to provide information browsing assistance, said locator identifying the first information page and a location from which the first information page is to be retrieved, and
conditionally provide said information browsing assistance based at least in part on said determination; and
at least one processor coupled to the storage medium to execute the executable instructions.

20. The apparatus of claim 19, wherein said locator is a uniform resource locator (URL).

21. The apparatus of claim 19, wherein said executable instructions are designed to enable the apparatus to perform said determining by analyzing whether a locator based condition for providing information browsing assistance is met.

22. The apparatus of claim 19, wherein
said locator is a uniform resource locator (URL); and
said executable instructions are designed to enable the apparatus to perform said determining by analyzing whether said URL satisfies a URL based condition for providing information browsing assistance is met.

23. The apparatus of claim 22, wherein
each URL based condition comprises a URL pattern specifying a family of URLs; and
said executable instructions are designed to enable the apparatus to perform said analysis by matching said URL against a plurality of URL patterns.

24. The apparatus of claim 23, wherein
each URL pattern comprises a plurality of portions correspondingly stored in a plurality of nodes of a tree data structure, with the plurality of nodes having a child leaf node specifying information browsing assistance to be provided; and
said executable instructions are designed to enable the apparatus to perform said matching comprises traversing said tree data structure.

25. The apparatus of claim 19, wherein said executable instructions are designed to enable the apparatus to provide said information browsing assistance by displaying a second information page.

26. The apparatus of claim 25, wherein said executable instructions are designed to enable the apparatus to display said second information page in a manner that effectively replaces said first information page.

27. The apparatus of claim 25, wherein said executable instructions are designed to enable the apparatus to additionally display said second information page complementary to said first information page.

28. The apparatus of claim 25, wherein said second information page comprises a plurality of locators identifying a plurality of information pages and corresponding locations from which the identified information pages of said second information page are to be retrieved.

29. The apparatus of claim 19, wherein said executable instructions are designed to enable the apparatus to provide said information browsing assistance by modifying an environment attribute of the browsing environment within which said determining and conditional provision of information browsing assistance are performed.

30. The apparatus of claim 29, wherein said environment attribute is an environment attribute selected from a group of environment attributes comprising a display resolution attribute, a color resolution attribute, a font selection attribute, a media player preference attribute, an add-on selection attribute, and a plug-in selection attribute.

31. The apparatus of claim 19, wherein said executable instructions are further designed to enable the apparatus to receive a request to retrieve and display said first information page, said request including said locator.

32. The apparatus of claim 31, wherein said executable instructions are designed to implement a browser helper including at least a monitor function and an analyzer function, with the monitor function of the browser helper being designed to receive a notification of said receipt, and in response, notifying said analyzer function of receipt of said notification, and said analyzer function in turn performs said determining and conditional provision of information browsing assistance.

33. The apparatus of claim 32, wherein said executable instructions are designed to implement said monitor function as an extension of a browser, and said analyzer function as an external function to said browser.

34. The apparatus of claim 33, wherein the apparatus is a selected one of a wireless telephone, a palm sized personal digital assistant, a notebook computer, a desktop computer, and a set top box.

35. In a first server system, a method of operation comprising:
receiving a request from a client system for executable instructions designed to enable the client system to conditionally provide information browsing assistance based at least in part on a locator of a first information page requested to be retrieved and displayed, said location identifying said first information page and a location from which said first information page is to be retrieved; and
in response, providing said client system with said requested executable instructions.

36. The method of claim 35, wherein said locator is a uniform resource locator (URL).

37. The method of claim 35, wherein said executable instructions are designed to perform a selected one of (a) enabling the client system to determine whether a locator based condition for providing information browsing assistance is met, and (b) enabling the client system to provide said locator to a second server system for the second server system to determine for said client system whether a locator based condition for providing information browsing assistance is met.

38. The method of claim 37, wherein said first and second server systems are the same server system.

39. The method of claim 35, wherein
said locator is a uniform resource locator (URL); and
said executable instructions are designed to perform a selected one of (a) to enable the client system to determine whether said URL satisfies a URL based condition for providing information browsing assistance is met, and (b) to enable the client system to provide said URL to a second server system for the second server system to determine for said client system whether a locator based condition for providing information browsing assistance is met.

40. The method of claim 39, wherein
each URL based condition comprises a URL pattern specifying a family of URLs; and
either (a) said executable instructions are designed to enable the client system to match said URL against a plurality of URL patterns, or (b) the method further comprises a second server system matching said URL against a plurality of URL patterns for said client system.

41. The method of claim 40, wherein
each URL pattern comprises a plurality of portions correspondingly stored in a plurality of nodes of a tree data structure, with the plurality of nodes having a child leaf node specifying information browsing assistance to be provided; and
either (a) said executable instructions are designed to enable the client system to perform said matching by traversing said tree data structure, or (b) the method further comprises a second server system performing said matching by traversing said tree data structure for said client system.

42. The method of claim 35, wherein either (a) said executable instructions are designed to enable the client system to provide said information browsing assistance by displaying a second information page or (b) the method further comprises a second server system providing said information browsing assistance to said client system by causing a second information page to be displayed on said client system.

43. The method of claim 42, wherein said second information page is displayed in a manner that effectively replaces said first information page.

44. The method of claim 42, wherein said second information page is additionally displayed in a manner that is complementary to said first information page.

45. The method of claim 42, wherein said second information page comprises a plurality of locators identifying a plurality of information pages and corresponding locations from which the identified information pages of said second information page are to be retrieved.

46. The method of claim 35, wherein either (a) said executable instructions are designed to enable the client system to provide said information browsing assistance by modifying an environment attribute of the browsing environment of said client system, or (b) the method further comprises a second server system providing said information browsing assistance to said client system by modifying an environment attribute of the browsing environment of said client system.

47. The method of claim 46, wherein said environment attribute is an environment attribute selected from a group of environment attributes comprising a display resolution attribute, a color resolution attribute, a font selection attribute, a media player preference attribute, an add-on selection attribute, and a plug-in selection attribute.

48. The method of claim 35, wherein said executable instructions are designed to implement a browser helper including at least a monitor function, designed to receive a notification of a receipt of a request for said first information page, and in response, notifying a analyzer function of receipt of said notification.

49. The method of claim 48, wherein either (a) said browser helper further includes said analyzer function to perform said conditional provision of information browsing assistance, in response to receipt of said notification, or (b) the method further a second server having said analyzer function to perform said conditional provision of information browsing assistance for said client system, in response to receipt of said notification from said client system.

50. A server system comprising:
storage medium having stored therein at least a selected one of
(a) first executable instructions designed to enable a first client system to conditionally provide information browsing assistance to itself based at least in part on a first locator of a first information page requested to be retrieved and displayed, and second executable instructions designed to provide the first client system with said first executable instructions in response to a request by the first client system for said first executable instructions, and
(b) third executable instructions designed to enable the server system to conditionally provide information browsing assistance to a second client system based at least in part on a second locator of a second information page requested to be retrieved and displayed for said second client system,
said first and second locators identifying said first and second information pages, and a first and a second location from which said first and second information pages are to be retrieved respectively; and
at least one processor coupled to the storage medium to execute at least one of said second and third executable instructions.

51. The server system of claim 50, wherein said locator is a uniform resource locator (URL).

52. The server system of claim 50, wherein
said first executable instructions are designed to enable the first client system to determine whether a first locator based condition for providing information browsing assistance is met, and
said third executable instructions are design to enable the server system to determine for said second client system whether a second locator based condition for providing information browsing assistance is met.

53. The server system of claim 50, wherein
each of said first and second locators is a uniform resource locator (URL);
said first executable instructions are designed to enable the first client system to determine whether said first URL satisfies a first URL based condition for providing information browsing assistance is met; and
said third executable instructions are design to enable the server system to determine for said second client system whether a second locator based condition for providing information browsing assistance is met.

54. The server system of claim 53, wherein
each URL based condition comprises a URL pattern specifying a family of URLs;
said first executable instructions are designed to enable the first client system to match said first URL against a first plurality of URL patterns; and
said third executable instructions are design to enable the server system to match said second URL against a second plurality of URL patterns for said second client system.

55. The server system of claim 54, wherein
each URL pattern comprises a plurality of portions correspondingly stored in a plurality of nodes of a tree data structure, with the plurality of nodes having a child leaf node specifying information browsing assistance to be provided; and
said first executable instructions are designed to enable the first client system to perform said matching by traversing a first tree data structure;
said third executable instructions are designed to enable the server system to perform said matching by traversing a second tree data structure for said second client system.

56. The server system of claim 50, wherein
said first executable instructions are designed to enable the first client system to provide said information browsing assistance by displaying a second information page; and
said third executable instructions are designed to enable the server system to provide said information browsing assistance to said client system by causing a second information page to be displayed on said client system.

57. The server system of claim 56, wherein said second information page is displayed in a manner that effectively replaces said first information page.

58. The server system of claim 56, wherein said second information page is additionally displayed in a manner that is complementary to said first information page.

59. The server system of claim 56, wherein said second information page comprises a plurality of locators identifying a plurality of information pages and corresponding locations from which the identified information pages of said second information page are to be retrieved.

60. The server system of claim 50, wherein
said first executable instructions are designed to enable the first client system to provide said information browsing assistance by modifying a first environment attribute of the browsing environment of said first client system; and
said third executable instructions are designed to enable the server system to provide said information browsing assistance to said client system by modifying a second environment attribute of the browsing environment of said second client system.

61. The server system of claim 60, wherein each of said first and second environment attributes is an environment attribute selected from a group of environment attributes comprising a display resolution attribute, a color resolution attribute, a font selection attribute, a media player preference attribute, an add-on selection attribute, and a plug-in selection attribute.

62. The server system of claim 50 wherein said first executable instructions are designed to implement a browser helper including at least a monitor function, designed to receive a notification of a receipt of a request for said first information page, and in response, notifying a analyzer function of receipt of said notification.

63. The server system of claim 62, wherein said browser helper further includes said analyzer function to perform said conditional provision of information browsing assistance, in response to receipt of said notification.
